(19) United States
(12) Patent Application Publication
(10) Pub. No.: US 2008/0113316 A1
(43) Pub. Date: May 15, 2008

(54) DENTAL IMPLANT FOR SUPPORTING A DENTAL PROSTHESIS

(75) Inventor: Manfred Menke, Korneuburg (AT)

Correspondence Address: RISSMAN JOBSE HENDRICKS & OLIVERIO, LLP, 100 Cambridge Street, Suite 2101, BOSTON, MA, 02114, US

(73) Assignee: Straumann Holding AG, Basel (CH)

(21) Appl. No.: 11/876,892

(22) Filed: Oct. 23, 2007

(30) Foreign Application Priority Data
Oct. 27, 2006 (EP) 06 022 472.2

(51) Int. Cl. A61C 8/00

(52) U.S. Cl. 433/174

(57) ABSTRACT

Dental implant (10) for supporting a dental prosthesis on a jaw bone, is equipped with a main body (12), which comprises a securing portion (14) intended to be anchored in the bone tissue and, lying opposite it, a head portion (16). The head portion (16) protrudes radially beyond the securing portion (14) with respect to the longitudinal axis of the main body (12) to form a support face (26), in such a way that, in the state of insertion in the jaw bone, the pressure of the dental implant (10) on the jaw bone is reduced, and a sinking movement of the dental implant (10) into the jaw bone is effectively avoided, even over quite long periods of time.

### FIELD OF THE INVENTION

The present invention relates to a dental implant for supporting a dental prosthesis on a jaw bone and to a dental implant system including said dental implant.

### BACKGROUND

Removable dental prostheses are usually fixed releasably to the jaw using so-called adhesive creams or mechanically on the residual dentition, which is equipped with special anchor elements for connection to the dental prostheses. Particularly at the rear free-end gaps, or in cases of particularly flat alveolar ridges presenting a small quantity of bone, the use of conventional dental implants is not possible, or is possible only with quite considerable effort.

The normal masticatory forces can also lead to the dental prosthesis sinking deeper into the jaw bone the longer it continues to be used. This results in the gum beneath the dental prosthesis being compressed, which can lead to extremely unpleasant pain for the person wearing the dental prosthesis. This can be expected to lead to bone degeneration and, consequently, to a lack of support of the posterior teeth and to joint changes.

### SUMMARY OF THE INVENTION

In accordance with one or more embodiments of the present invention, a dental implant is provided for supporting a tooth prosthesis on a jaw bone, which dental implant can be of a particularly simple structure, can be inexpensive to manufacture, can be safely fitted in the jaw bone and, over the long term, can avoid a sinking movement of the entire assembly including the dental prosthesis.

The dental implant system according to one embodiment of the invention comprises a substantially cylindrically symmetrical, one-piece main body, which is divided into a securing portion and a head portion. The securing portion is used for anchoring the dental implant in the bone tissue. The head portion is oriented in the coronal direction, when the dental implant is in the inserted state in the jaw bone, and it supports a dental prosthesis, lying on top of it, against the jaw bone. According to the invention, the head portion protrudes beyond the securing portion radially or at right angles with respect to the longitudinal axis of the main body. This protruding configuration results in the formation of a support face, which extends substantially perpendicular to the longitudinal axis and which ensures that the forces exerted by the tooth prosthesis on the dental implant are distributed over a greater surface area compared to the cross section of the securing portion, and thus ensures that the supported tooth prosthesis does not sink in the direction of the jaw bone.

By virtue of its simple structure, the dental implant according to one embodiment of the invention can be produced in small dimensions and inexpensively. The dental implant can therefore also be used in free-end gaps and in cases where there are particularly flat alveolar ridges presenting only a small quantity of bone. By virtue of the cylindrically symmetrical main body, known drilling techniques can be employed for installation into the jaw bone.

The dental implant system according to one embodiment of the invention comprises, in addition to the dental implant, a dental drill with a drill stop for particularly simple production of an implant-specific recess in the jaw bone, and an anchor element that can be mounted on the dental implant. The anchor element makes it possible to produce a releasable connection between the dental implant and the tooth prosthesis and thus permits, in addition to the supporting function, a securing function.

### BRIEF DESCRIPTION OF THE DRAWINGS

Particular embodiments of the dental implant according to the invention and of the dental implant system are described in detail below with reference to the attached drawing, in which:

FIG. 1 shows a phantom view through a dental implant according to one embodiment of the invention, with a rounded contact face on the head portion, which contact face surrounds an opening of a blind hole equipped with an inner thread;

FIG. 2 shows a perspective phantom view through the dental implant shown in FIG. 1;

FIG. 3 shows a phantom view of another embodiment of a dental implant according to the invention, with a contact face in the shape of a segment of a sphere;

FIG. 4 shows a perspective phantom view through the dental implant shown in FIG. 3;

FIG. 5 shows a sectional view through a part of a jaw bone, through a dental implant according to one embodiment of the invention and through a dental prosthesis, where a support element engaged in the dental prosthesis, on the alveolar ridge side, rests on the contact face of the dental implant;

FIG. 6 shows a side view of the support element depicted in cross section in FIG. 5;

FIG. 7 shows a perspective phantom view through the support element shown in FIG. 6;

FIG. 8 shows a partial phantom view through a dental implant according to one embodiment of the invention, in which an anchor element with a spherical anchor head is screwed onto the dental implant;

FIG. 9 shows a section through an ampule for transport and storage of a dental implant according to one embodiment of the invention; and

FIG. 10 shows a dental drill with two drill sections which have different diameters and lie one behind the other in the direction of advance, and with a drill stop, which dental drill is used to create a recess in the jaw bone for receiving a dental implant according to one embodiment of the invention.

### DETAILED DESCRIPTION

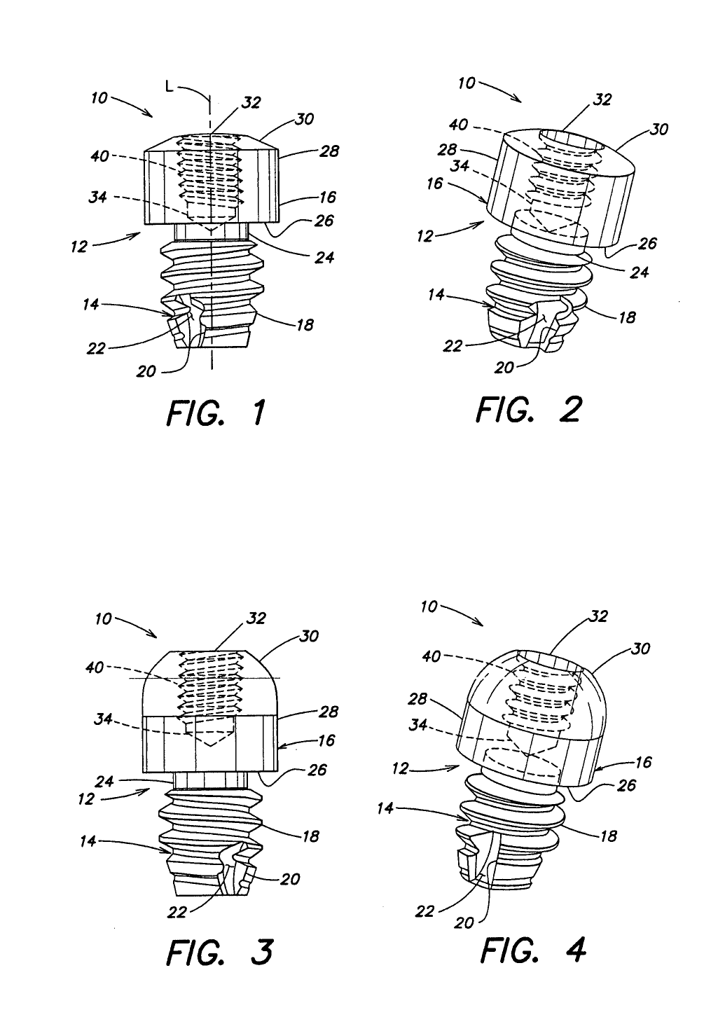

The dental implant 10 according to one embodiment of the invention shown in FIGS. 1-4 comprises a substantially cylindrically symmetrical, screw-like main body 12, which is divided into a securing portion 14 and a head portion 16. The securing portion 14 is provided with a self-cutting outer thread 18 and is used for anchoring in the tissue of a jaw bone. The self-cutting property of the outer thread 18 is achieved by cutting edges 20, which partially delimit a groove 22 in the outer thread 18. The groove 22 is used to guide tissue material away while the dental implant 10 is being screwed into the jaw bone, and it makes the dental implant 10 easier to screw in. In the securing portion 14, at the end toward the head portion, the outer thread 18 is adjoined by an undercut 24 which, for production reasons, is not provided with thread turns.

The head portion 16 is mushroom-shaped, and its cross section protrudes radially beyond the cross section of the securing portion 14 to form a support face 26. In the particularly preferred design of the dental implant 10 with a cylindrically symmetrical main body 12, the support face 26 forms a circular ring. The cross section of the head portion 16, enlarged by the support face 26, has the effect that forces acting on the dental implant 10 in the direction of its longitudinal axis L apply less pressure to the jaw bone, thus avoiding a sinking movement of the dental implant and of a dental prosthesis supported on the latter, in other words, of the whole assembly.

In the head portion 16, the support face 26 is adjoined by a radially outwardly directed head circumference surface 28, seen in the longitudinal direction away from the securing portion 14. The head circumference surface 28 is designed as a cylinder jacket. In the embodiments of a dental implant 10 according to the invention shown in FIG. 1 to FIG. 4, it extends at least approximately parallel to the longitudinal axis L of the main body 12. Alternatively, the head circumference surface 28 can also taper conically or be equipped with edges.

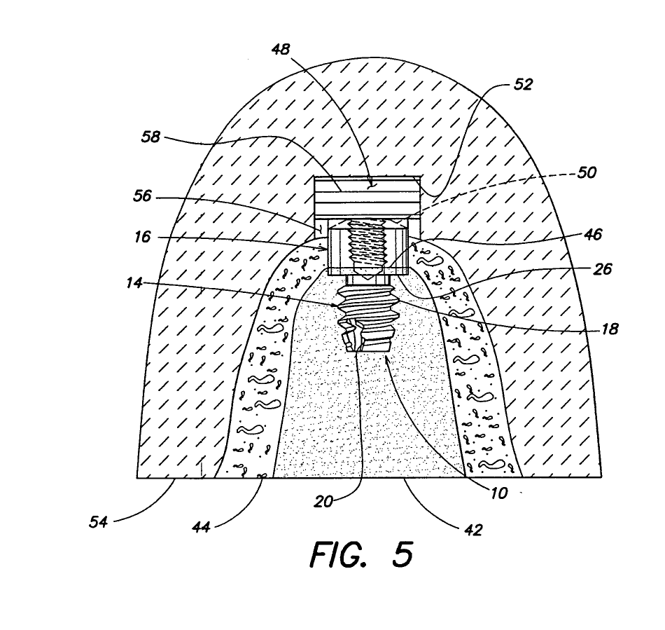

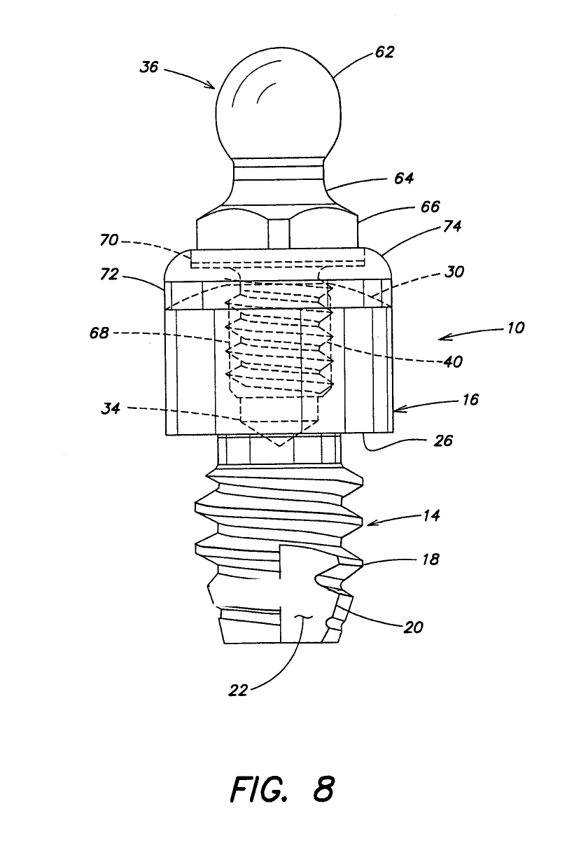

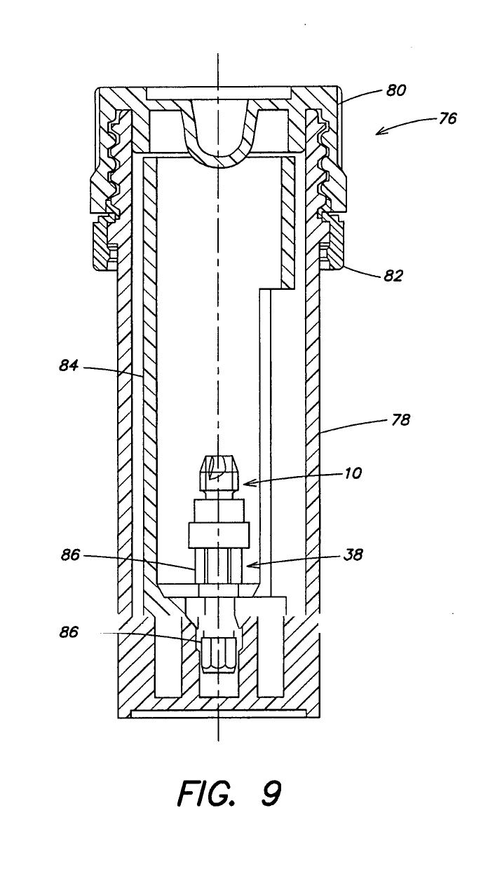

At the end area, directed away from the securing portion 14, the head circumference surface 28 is adjoined by a contact face 30. When the dental implant 10 is in its inserted state in the jaw bone, the contact face 30 forms the coronally oriented limit face of said dental implant 10. The contact face 30 surrounds an opening 32 of a blind hole 34, which extends coaxially with respect to the longitudinal center axis L of the main body 12 and reaches into the head portion 16. As can be seen very clearly in the phantom views of the dental implant 10, the blind hole 34, for the purpose of creating a screwed connection, is equipped with an inner thread 40 for engaging a dental screw (not shown), an anchor element 36 (shown in FIG. 8) or a screw-in adapter 38 (shown in FIG. 9). For the case shown in FIG. 5, where no anchor element 36 is to be mounted on the dental implant 10, the blind hole 34 is sealed with a biocompatible filler material after the dental implant 10 has been fitted and the screw-in adapter 38 has been removed.

As in the embodiment of the dental implant 10 according to the invention shown in FIG. 1 and FIG. 2, the contact face 30 can rise in a circular cone shape from the head circumference portion 28 to the opening 32, or, as in the embodiment shown in FIG. 3 and FIG. 4, it can form a surface in the shape of a segment of a sphere.

The total length of the dental implant 10 is between 4 mm and 10 mm, preferably 6 mm, the length of the securing portion, measured along the longitudinal axis of the main body 12, is 3 mm to 5 mm, preferably 3.5 mm, and the length of the head portion 16, also measured along the longitudinal axis, is between 2 mm and 4 mm, preferably 2.5 mm. The diameter of the head portion 16 is between 3 and 6 mm, preferably 4 mm. The inner thread chosen for the blind hole 34 is preferably M 1.8. The self-cutting outer thread in the securing portion 14 is preferably equipped with a core diameter of 2.2 mm, an external diameter of 3 mm, a flank angle of approximately 60°, and a pitch of approximately 0.7 mm.

Materials that can be used to produce the dental implant 10 are preferably titanium and titanium alloys, zirconia or other biocompatible materials, preferably metal alloys.

In FIG. 5, the dental implant 10 of the embodiment shown in FIGS. 1 and 2 is shown in the state when inserted into the jaw bone 42. The securing portion 14 is received completely in the jaw bone 42, while the head portion 16 situated radially outside is substantially surrounded by the gum 44 located above the jaw bone 42.

Approximately at the level of the limit face between the jaw bone 42 and the gum 44, a contour line 46 is visible, to which the head portion 16 is embedded in the bone tissue. Measured in the longitudinal direction, the depth of the embedding is approximately 0.2 mm to 0.8 mm, preferably 0.5 mm.

The part of the surface of the dental implant 10 surrounded by the tissue of the jaw bone 42 below the contour line 46 is specifically functionalized by being roughened (e.g. by etching), by other forms of surface treatment (e.g. by sandblasting) and/or by a coating (e.g. plasma spray process), in order to obtain a more intensive interaction of the bone tissue with the functionalized surface and thus improve the anchoring of the dental implant 10 in the jaw bone 42 (osseointegration). The strongest biochemical bond is achieved at a surface roughness of approximately 1.5 μm (mean roughness value Rₐ) (G. Hansson, J. Biochem. 2000, 33: 1297-1303); an optimal surface structure is obtained at a mean roughness value Rₐ of approximately 1 μm and an average peak-to-valley height R_{z} of 11 μm (A. Wennerberg, thesis, University of Gothenburg, 1996). The figures for the mean roughness values and the average peak-to-valley height correspond to the definition according to DIN 4768. Alternatively, a smaller or larger part of the surface of the dental implant 10 can of course be equipped with a functionalized or roughened surface.

According to the sectional view shown in FIG. 5, the dental implant 10 is preferably screwed to such a depth into the jaw bone 42 that the contact face 30 protrudes above the outer surface of the gum 44. A support element 48 functioning as patrix lies directly on the contact face 30 acting as matrix.

The support element 48 is provided, at the dental implant side, with a bearing face 50 which has a negative shape corresponding to the contact face 30. By virtue of the convex design of the contact face 30 and the correspondingly concave design of the bearing face 50, this matrix/patrix construction not only has a purely supporting function, but also to some extent a centering function.

To avoid penetration of liquids, bacteria and food residues in the detachable embodiment shown in FIG. 5, where the dental prosthesis 54 rests on the dental implant 10 by way of the support element 48, the blind hole 34 is, as has already been mentioned, sealed with a suitable filler compound in the head portion 16 of the dental implant 10.

The disk-like support element 48 shown in the sectional view in FIG. 5, with a substantially cylindrical cross section, is either pressed into a corresponding prosthesis seat 52 of the prosthesis 54 and optionally bonded with adhesive, or it has been cast integrally with the prosthesis 54 at the time of production. In the latter case in particular, hollow spaces 56 between the outer surface of the gum 44 and the bearing face 50 protruding beyond the contact face 30 can be filled with biocompatible filler material.

In the same way as for the dental implant 10 itself, the materials preferably used for the support element 48 are titanium and titanium alloys, zirconia or other biocompatible materials, preferably metal alloys.

The support element 48 has an external diameter of between 4 mm and 5.5 mm, preferably of 5.5 mm. The height of the support element 48 is between 2 mm and 4 mm, preferably 2.5 mm.

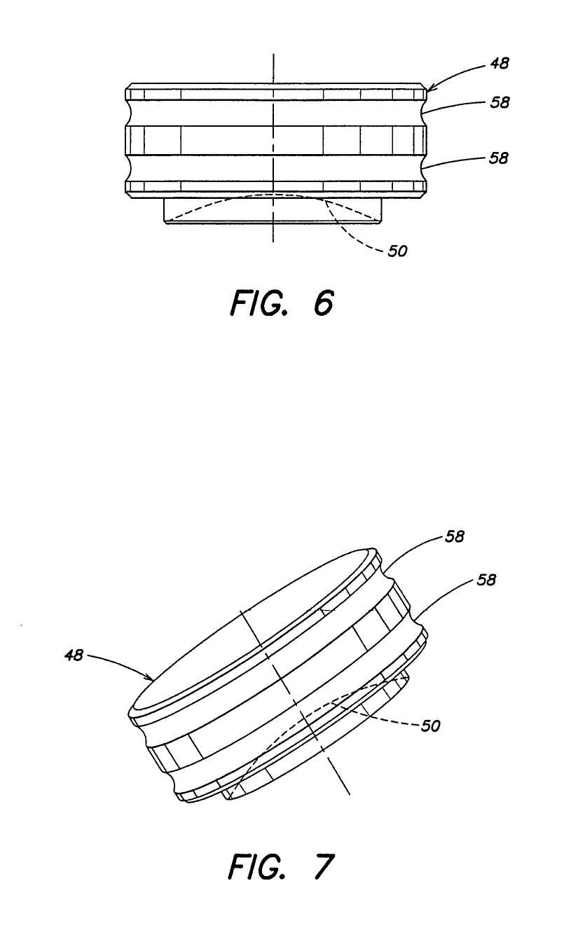

FIGS. 6 and 7 show the details of the support element 48. In addition to the concavely curved bearing face 50, two radially outwardly directed retention grooves 58 are visible. These retention grooves 58 serve for better anchoring of the support element 48 in the dental prosthesis 54.

In addition to the supporting function described above, the dental implant 10 can also perform a securing function by connecting it to an anchor element 36 having the shape of a spherical head, for example as shown in FIG. 8. In this case, the support element 48 (not shown) in the dental prosthesis 54 is designed, for example, with an elastically deformable or resilient bearing face 50 in the shape of a hollow sphere, such that a releasable connection, for example a click connection, is produced between the dental prosthesis 54 and the dental implant 10 connected fixedly to the anchor element 36.

In the anchor element 36 as shown in FIG. 8, the anchor head 62, here of spherical design, is adjoined, in the direction toward the implant, by a tapered anchor neck 64, and the latter in turn is adjoined by a substantially hexagonal anchor attachment 66. This anchor attachment 66 serves in particular for interaction with a screwing tool, for example a wrench, when screwing the anchor element 36 into the blind hole 34 provided for it in the head portion 16 of the dental implant 10.

Before the transition of the anchor attachment 66 into an anchor root 68 provided with a corresponding outer thread, the anchor element 36 widens to form an annular anchor disk 70. In the view shown in FIG. 8, the anchor disk 70 sits in a corresponding inner and centrally positioned recess of a washer 72, which serves to secure the anchor element 36 on the dental implant 10 against inadvertent loosening of the anchor element 36. In the embodiment shown, the washer 72 is secured on the anchor disk 70 of the anchor element 36 via a flange.

Alternatively, it is of course also possible to form the washer 72 directly on the anchor element 36, that is to say in one piece, or to form the washer 72 and the anchor element 36 as two individual elements. The washer 72, like the anchor element 36, is preferably made of a biocompatible metal alloy or of other suitable biocompatible materials (e.g. ceramic). In addition to having a through-hole, it also has a rounded configuration 74 on the outside, at the end directed toward the anchor head. The underside of the washer 72, directed toward the dental implant, is provided with a negative form of the contact face 30 of the dental implant 10.

After the dental implant 10 has been produced, and before it is fitted into the corresponding bore in the jaw bone 42, the dental implant 10, together with its screw-in adapter 38, is stored and transported in a preferably sterile state in an ampule 76 shown in FIG. 9. The ampule 76 comprises a substantially cylindrical ampule body 78, which is closed off at one end and can be sealed with an ampule cap 80 at the other end. For this purpose, the ampule body 78, and the ampule cap 80 also, are provided with mutually adapted screw threads. The first time the ampule cap 80 is unscrewed from the ampule body 78, a fastening ring 82 that connects the two elements to one another with a form fit is irreversibly separated from the ampule cap 80.

A removable ampule insert 84 is located in the interior of the ampule body 78. The screw-in adapter 38 is fitted in this ampule insert 84, again in a removable manner. The screw-in adapter 38 is equipped with a screw extension (not visible in FIG. 9) whose outer thread interacts with the inner thread of the blind hole 34 of the dental implant 10 in such a way that a releasable screwed connection is produced between the screw-in adapter 38 and the dental implant 10. The screw-in adapter 38 also has two hexagonal engagement portions 86 which, in cooperation with a known dental tool, allow the dental implant 10 to be screwed into the jaw bone 42.

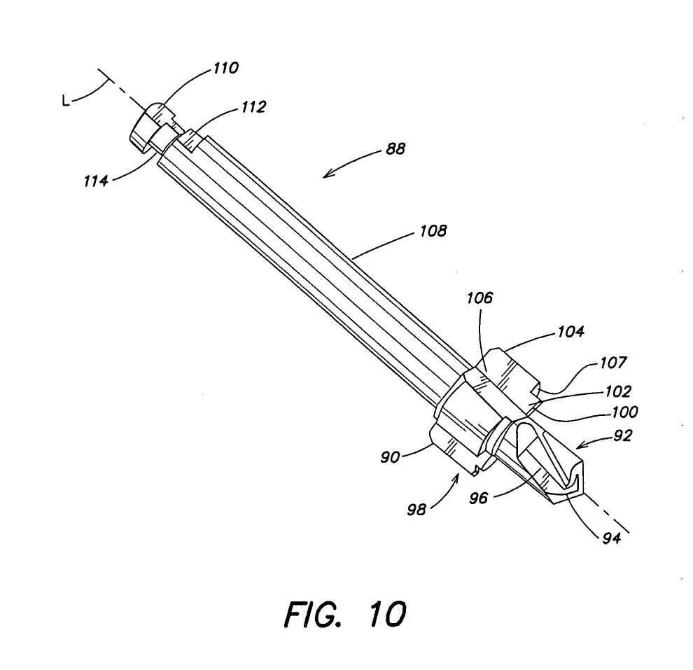

Before the dental implant 10 can be screwed into the jaw bone 42, the gum 44 is first removed from the site in question, and a suitable recess is drilled in the jaw bone 42 using the dental drill 88 shown in FIG. 10. Along its longitudinal axis L, the dental drill 88 has a drill head 90 at the drilling end area. The drill head 90 is subdivided by three different cross-sectional areas into three portions: a first drill portion, which tapers to a point in the manner of a spiral drill at the end area and is equipped there with first cutting edges 94 and helical first drill grooves 96 for leading drill debris away, a second drill portion 98 whose cross section is greater than that of the first drill portion 92 and which is equipped with second cutting edges 100 and with second drill grooves 102 which are configured more or less in a continuation of the first drill grooves 96, and a drill stop 104 whose cross section is in turn greater than that of the second drill portion 98 and is provided, in a continuation of the second drill grooves 102, with third drill grooves 106, and which, in contrast to the second drill portion 98, has no cutting edges 100, but instead has radially extending abutment faces 107.

The first drill portion 92 is used to drill out a recess in the jaw bone 42 with approximately the core diameter of the self-cutting outer thread 18 of the dental implant 10. As the drilling operation continues, the second drill portion 98 adjoining the first drill portion 92 in the longitudinal direction leads to the formation of the previously described enlarged recess in the gum, which permits partial embedding of the head portion 16 as far as the contour line 46 shown in FIG. 5. With its abutment faces 107, the drill stop 104 acts as a limit stop, such that, upon completion of the drilling operation, the recess in the jaw bone 42 has exactly the required depth for receiving the dental implant 10, and undesired further deepening of the drilled hole in the jaw bone 42 is avoided.

The drill head 90 of the dental drill 88 is adjoined by a cylindrical drill shaft 108 which, at the end directed away from the drill head 90, terminates in a tool-coupling element 110. The tool-coupling element 110 is designed to be received by a standardized chuck of a drive element. On the tool-coupling element 110, a recess in the shape of a cylinder segment is formed in the circular cylindrical drill shaft 108 in order to create a substantially plane coupling surface 112. Upon interaction with a corresponding mating surface of the receiving chuck, the coupling surface 112 serves to transmit a torque to the dental drill 88. The tool-coupling element 110 is also provided with a coupling groove 114, which extends in the circumferential direction and which serves to axially fix the dental drill 88 in the chuck.

Embodiments of the above-described dental implant 10 according to the invention, a dental drill 88 adapted to the specific weight of the dental implant 10, and an anchor element 36 likewise constructed for the specific dental implant 10, are generally produced and marketed together as a dental implant system. This ensures that the dental implant 10 is inserted with an exact fit into a recess formed in the jaw bone 42 by means of the associated dental drill 88, and that the anchor element 36 can be easily mounted on the dental implant 10. In addition to the comparatively inexpensive production of the relatively simply constructed dental implant 10, the production and marketing of the corresponding dental implant system simplifies and standardizes the installation of the dental implant 10 and makes it more reliable and more cost-effective.

1. A dental implant for supporting a dental prosthesis on a jaw bone, with a substantially cylindrically symmetrical main body, which comprises, along its longitudinal axis, a securing portion intended to be anchored in the jaw bone, and a head portion arranged at the opposite end area, the head portion protruding radially beyond the securing portion with respect to the longitudinal axis of the one-piece main body to form a support face, and the support face extends substantially perpendicular to the longitudinal axis.

2. The dental implant as claimed in claim 1, having a total length of between 4 mm and 10 mm, a diameter of the head portion of between 3 mm and 6 mm, and a cross section of the securing portion of between 2 mm and 4 mm.

3. The dental implant as claimed in claim 1, wherein the securing portion is equipped with a self-cutting outer thread.

4. The dental implant as claimed in claim 1, wherein the surface of the securing portion, the support face and at least part of a head circumference face of the head portion adjoining the support face are equipped with a functionalized, roughened surface having a mean roughness value of 1.5 μm to 2 μm and an average peak-to-valley height of 5 μm to 15 μm.

5. The dental implant as claimed in claim 1, wherein the dental implant is equipped with a blind hole, which has an opening in a contact face of the head portion at the end area, and this contact face is plane or convexly curved.

6. The dental implant as claimed in claim 5, wherein the contact face widens conically outward from the opening in the direction of the securing portion or is designed in the shape of a segment of a sphere.

7. The dental implant as claimed in claim 5, wherein the blind hole is equipped with an inner thread for connection to an anchor element, which serves not only to support but also to secure the dental prosthesis on the dental implant.

8. A dental implant system, comprising a dental drill with a drill stop, a dental implant as claimed in claim 1, and an anchor element that is secured on the dental implant and serves to create a releasable connection between the dental prosthesis and the dental implant.

9. The dental implant system as claimed in claim 8, wherein the anchor element has an anchor head in the shape of a sphere or a segment of a sphere.

10. The dental implant system as claimed in claim 8, wherein the dental drill comprises two drill sections which have different diameters and lie one behind the other in the direction of advance, and it also comprises a drill stop.

11. The dental implant system as claimed in claim 2, wherein the total length is 6 mm.

12. The dental implant system as claimed in claim 11, wherein the diameter of the head portion is 4 mm.

13. The dental implant system as claimed in claim 12, wherein the cross section of the securing portion is 3 mm.

14. The dental implant system as claimed in claim 4, wherein the mean roughness value is approximately 1 μm.

15. The dental implant system as claimed in claim 14, wherein the average peak-to-valley height is approximately 11 μm.
